(19) United States
(12) Patent Application Publication
(10) Pub. No.: US 2016/0292243 A1
(43) Pub. Date: Oct. 6, 2016

(54) Data Management System

(71) Applicant: RIMES Technologies Corporation, New York, NY (US)

(72) Inventors: Frederic Mancuso, London (GB); Christian Fauvelais, London (GB)

(21) Appl. No.: 14/674,430

(22) Filed: Mar. 31, 2015

(51) Int. Cl. G06F 17/30; H04L 29/06; G06F 7/06; G06F 3/0482; G06Q 40/06; G06F 3/0484

(52) U.S. Cl. CPC G06F 17/30569; G06F 17/30867; G06F 17/3056; G06F 17/30994; G06Q 40/06; G06F 3/04842; G06F 7/06; G06F 3/0482; H04L 67/42

(57) ABSTRACT

There is provided a data management system for managing flow of data though from a plurality of inputs (IP1-IP4) to a plurality of outputs (OP1-OP4) via a data transformation element (20). The system comprises a plurality of control points (1-8) and a first graphical display (50) of the inputs, outputs, and the data transformation element. Each control point determines the quality of the data at a respective point in the data flow between the inputs and outputs, and each control point is represented in the first graphical display together with a visual indication of the data quality determined by the control point.

### FIELD OF THE INVENTION

The present invention relates to a data management system for managing flow of data from a plurality of inputs to a plurality of outputs, via at least one data transformation element.

### BACKGROUND TO THE INVENTION

In today's world, huge quantities of data is routinely logged and stored, and effective use of this vast amount of information presents a significant problem. Stored data can be an extremely effective tool for evaluating past events and for risk management calculations, however to maximize its effectiveness careful control over how the data is used must be exercised. For example, the data must be sufficiently accurate and up to date, and must include all the relevant information, but no more information than is necessary for the purpose for which it is being used. Clearly, if insufficient data is included in an analysis, then important aspects may be missed, whereas if too much data is included in an analysis, then important aspects may be obscured by the sheer bulk of data.

Organizations commonly receive large amounts of data from disparate sources, and then filter and/or transform the data according to the purposes for which the data is required.

In organizations which are heavily dependent upon data, for example financial institutions, it is very important to regulate the flow of data through the organization, so the various parts of the organization receive the correct data that they require. An organization may appoint data managers whose primary function is to ensure that data is being gathered and effectively deployed to the various parts of the organization. However the management of data in a large organization is a huge on-going task, as the data which is received soon becomes out of date, and the types and formats of data received from various sources inevitably varies over time, as does the types and formats of data required by different parts of the organization. It is common for different parts of an organization to have different requirements for the data that is operated upon, for example some parts of the organization may require a very narrow selection of the data, but for this selection to be to be very up-to-date and precise, whereas other parts may require a wider selection of the data but with lower temporal and accuracy requirements.

There is therefore a requirement for a data management system which can be used to help manage the flow of data between a plurality of data inputs to a plurality of data outputs.

### SUMMARY OF THE INVENTION

According to a first aspect of the invention, there is provided a data management system for managing flow of data though from a plurality of inputs to a plurality of outputs via a data transformation element. The system comprises a plurality of control points and a first graphical display of the inputs, outputs, and the data transformation element. Each control point determines the quality of the data at a respective point in the data flow between the inputs and outputs, and each control point is represented in the first graphical display together with a visual indication of the data quality determined by the control point.

The data may for example comprise at least one of financial benchmarking data, financial portfolio data, and complex market data, wherein complex market data includes derivatives, private equity, commodities, or hedge funds.

The use of a graphical display means that the qualities of the data at various points in the organization can all be viewed together at once so the viewer receives a quick overview of all the current statuses of the data, and any lapses in data quality at any of the control points can be easily identified. The first graphical display may for example be displayed on an electronic display screen, such as an electronic display screen of a smartphone, tablet, laptop or desktop computer.

Each control point preferably determines the quality of the data based upon a criteria set that is specific to that control point. Each criteria set specifies the criteria that the data is judged against when determining its quality. The quality of data is defined as the fitness for purpose of the data. Accordingly, a control point having data passing through it that is to be used for precision calculations may have a much more stringent criteria set than a control point having data passing through it which is to be used for identifying general trends.

The data transformation element receives data from the plurality of inputs and transforms the data into forms desired by each one of the plurality of outputs. For example, each one of the plurality of outputs may require different selections of the overall quantity of data received from the data inputs, in different data formats, with different temporal and/or accuracy requirements. Data may be continually received at the plurality of inputs from data feeds, and this data may be stored by the data transformation element and periodically sent to one or more of the plurality of outputs, and/or sent upon request from one or more of the plurality of outputs. According, the transforming of the data may comprise at least one of formatting, organizing, and filtering the data. Additionally, the formatting, organizing, or filtering of the data may include buffering the data.

The Applicant's earlier PCT patent application publication WO2014/049327, which is hereby incorporated by reference, discloses a plurality of service providers, a plurality of clients, and a server which regulates the flow of data from the plurality of service providers to the plurality of clients. The server may constitute the data transformation element of the present invention. Furthermore, the plurality of service providers may be connected to the plurality of inputs of the present invention, and the plurality of clients may be connected to the plurality of outputs of the present invention.

Accordingly, the data transformation element may transform the data using a first set of transformation parameters for data which is sent to one of the outputs, and using a second, different, set of transformation parameters for data which is sent to another one of the outputs. Then, the data transformation element may send each output the correct data that the output requires.

The control points may comprise inbound control points between the inputs and the data transformation element in the data flow, and outbound control points between the data transformation element and the outputs in the data flow. The control points may each determine the data quality according to a respective criteria set, the criteria sets being different to one another so that each control point determines data quality according to the purpose for which the data passing through the control point is intended.

The visual indication of the data quality determined by the control point may be displayed in any convenient manner, for example by including icons, warnings, messages etc. in the first graphical display. Advantageously, the control point may be represented by an icon which has a color displaying the data quality of the data passing through the control point. The colors may comprise Green to indicate the data quality is fit for purpose, Amber to indicate the data quality is borderline, and Red to indicate the data quality is not fit for purpose.

Each control point may judge the quality of the data passing through it according to whether the accuracy of the data meets one or more specified criteria, whether the completeness of the data meets one or more specified criteria, and whether the appropriateness of the data meets one or more specified criteria. The criteria for accuracy may define how accurate and up to date the data needs to be, the criteria for completeness may define the data items which should be included in the data, and the criteria for appropriateness may require that no more than a given set of data types should be included in the data. Advantageously, the visual indication of the data quality may comprise visual indications of each one of the accuracy, completeness, and appropriateness of the data.

So that more information on the determined quality of the data at each control point can be provided, the control points on the first graphical display may be selectable by a viewer of the first graphical display. For example, the first graphical display may be displayed on a display device such as a touchscreen so the control points can be selected by touching them, or the first graphical display may be displayed on a computing device with a pointer or cursor which can be used to select the control points. The selection of a control point results in the display of more detailed information on the quality of the data at the point in the data flow corresponding to the selected control point. In one embodiment, the more detailed information comprises information on at least one of the accuracy, completeness, and appropriateness of the data.

The more detailed information may be displayed in a second graphical display, wherein the second graphical display includes an inventory of data partners from which the data at that control point was obtained. Each data partner may be a service provider that provides data feeds of data, from one or more data sources, to one or more of the plurality of inputs. The second graphical display preferably displays information on data quality for each one of the data partners in the inventory. For example, the second graphical display may show a list of the data partners, each data partner associated with an icon that has a color according to the quality of data that is received from that data partner. The color is preferably set according to the accuracy, completeness, and appropriateness of the data received from the respective data partner.

The second graphical display may be displayed in a new window on the display screen compared to the first graphical display, for example the second graphical display may be displayed in a pop-up box when a mouse cursor is hovered over the control point in the first graphical display. Or, the second graphical display may be displayed in a separate window to the first graphical display, or may be displayed in the same window as the first graphical display such that it overwrites the first graphical display.

The data partners of the inventory of data partners on the second graphical display may be selectable by a viewer of the second graphical display, and the selection of a data partner may results in the display of a third graphical display including an inventory of data sources for the selected data partner. Each data source may for example be a data feed providing data on a given entity, for example pricing data of a given financial portfolio. Similarly to the second graphical display, the third graphical display may show a list of the data sources for the selected partner, each data source associated with an icon that has a color according to the quality of data that is received from that data source. Furthermore, the data sources may be selectable by a viewer of the third graphical display, and the selection of a data source results in the display of a fourth graphical display including an inventory of benchmarks for the selected data source. Accordingly, pricing data of a given financial portfolio may be compared to a pricing data of a benchmark, such as an average of stock or portfolio prices in a given financial sector. Similarly to the second graphical display, the fourth graphical display may show a list of the benchmarks for the selected data source, each benchmark associated with an icon that has a color according to the quality of data that is received from that data source.

The plurality of inputs, control points, and the data transformation element may be implemented on a server computer, the server computer being configured to output the first graphical display to a client computing device over a network such as the Internet. Accordingly, the server computer can maintain the control points and a user of the client computing device can access the server computer whenever desired to retrieve the first graphical display showing the control points and the quality of the data at the control points. The server computer may be configured to output the data from the plurality of outputs to a respective plurality of client data systems over the network, and each control point between the data transformation element and a respective output determines the quality of data according to a criteria set that is defined by the client data system to which the output outputs the data.

The data management system may further comprise a plurality of client control points, wherein the client control points receive data from outputs of the client data systems, and wherein each client control point determines the quality of the data it receives. Each client control point is represented in the first graphical display together with a visual indication of the data quality determined by the client control point. Therefore, an organization may use the server to monitor the quality of data that is output by its own data systems, and view the first graphical display to get an overview of the flow and quality of the data right from the initial data feeds at the inputs, through the data transformation element, and through their own organization.

So that the data quality determined by the client control points can be included in the first graphical display, the client control points may be implemented on the server computer, with the data from the outputs of the client data systems being received by the server computer over the network, or the client control points may be implemented on a client computer, with the quality of data determined by each client control point being sent to the server computer over the network.

### BRIEF INTRODUCTION TO THE DRAWINGS

Embodiments of the invention will now be described by way of non-limiting examples and with reference to the accompanying drawings, in which:

FIG. 1 shows a first graphical display according to an embodiment of the invention;

FIG. 2 shows a navigation chart of moving between the first to fourth graphical displays;

FIG. 3 shows a block diagram of a data management system according to an embodiment of the invention;

### DETAILED DESCRIPTION OF EMBODIMENTS

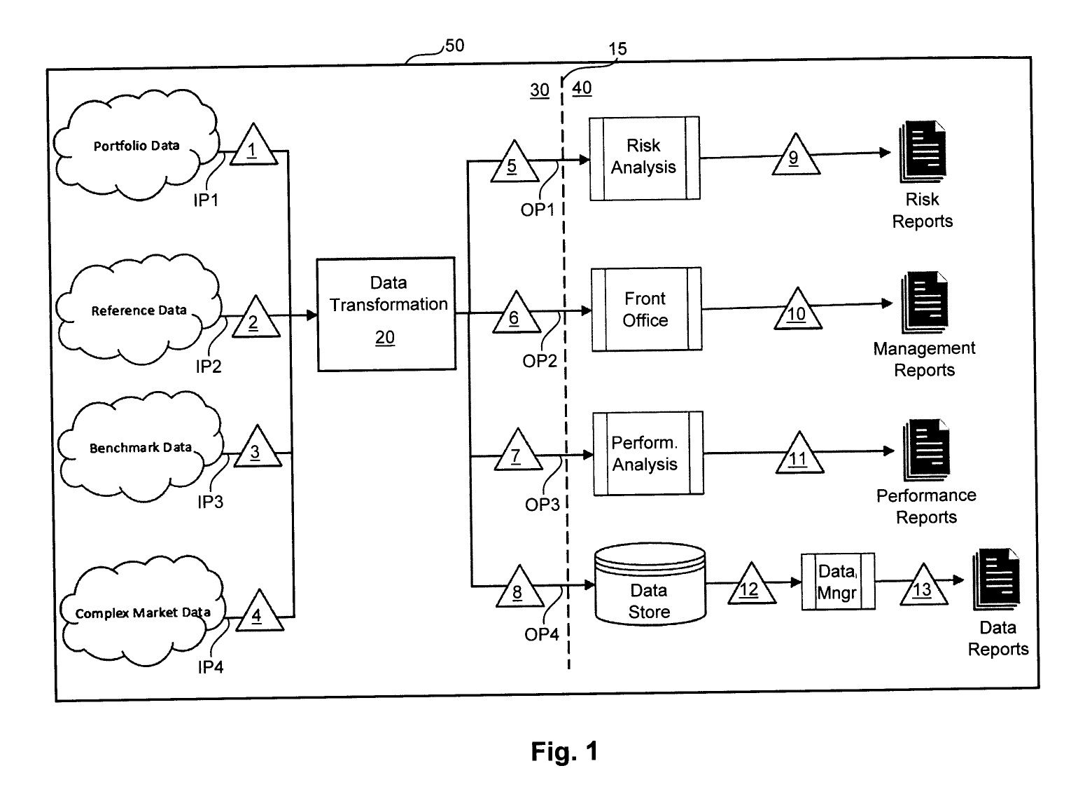

The graphical display 50 shown in FIG. 1 is displayed on a screen of a computing device, such as a smartphone, tablet, or desktop/laptop computer. According the graphical display 50 is electronically displayed. The graphical display 50 provides an overview of data flow from a plurality of inputs to a plurality of outputs via a data transformation element. In this particular embodiment, there are four inputs connected to four data sources, the first input IP1 receives Portfolio Data, such as price information on a portfolio of stocks or shares, the second input IP2 receives Reference Data, for example industry classifications for equity securities and bond ratings for fixed income instruments. The third input IP3 receives Benchmark Data, such as an average of stock or portfolio prices in a given financial sector, and the fourth input IP4 receives Complex Market Data, such as derivatives, private equity, commodities, or hedge funds. The data is continuously fed to the inputs IP1-IP4 by the data sources, in the form of data feeds. Clearly, the labels IP1-IP4 may be omitted from the graphical display for clarity.

The four inputs IP1-IP4 are connected to four respective inbound control points, 1-4. Each inbound control point is configured to check that the data flowing through the control point is fit for purpose, i.e. that it is sufficiently up-to-date and precise, (i.e. an accuracy requirement), that it includes all the required data (i.e. a completeness requirement), and no more data than the required data (i.e. an appropriateness requirement). The accuracy, completeness, and appropriateness of the data is judged based on a criteria set that specifies how accurate the data must be, how complete the data must be, and how appropriate the data must be. The data flowing through the control point is scored on the accuracy, completeness, and appropriateness requirements based on the criteria set, and a combined score is generated.

A high combined score means that the data is of acceptable quality, however if the score falls below a first threshold then the data is of borderline quality, and if the score falls below a second threshold that is lower that the first threshold, then the data is of unacceptable quality. In this embodiment, each control point in the graphical display is a triangle in a color that corresponds to the quality of data flowing through the control point. For example, a Green color if the data quality is acceptable, Amber color if the data quality is borderline, and a Red color if the data quality is unacceptable. Accordingly, a user can view the graphical display and instantly see the quality of the data flowing through each control point by the color of the control point in the graphical display.

In alternate embodiments, each control point could display three colors corresponding to the respective scores on the accuracy, completeness, and appropriateness requirements of the data flowing through the control point. Or, the scores could be displayed numerically or symbolically, rather than by using colors.

The criteria sets of the inbound control points may be set according to the quality of data that each data sources purports to provide, so that it can be immediately seen when the data from the data sources falls below the quality that is meant to be provided. Alternatively, the criteria sets of the inbound control points may be set according to a minimum data quality required by the data transformation element, so that the data quality will only be judged as unacceptable when the received data does not match up to the quality required by the data transformation element, rather than the data quality that the data source seeks to provide.

The inbound control points 1-4 send the data that they receive to a data transformation element 20, which stores the data. The data is filtered and re-formatted according to the requirements of four different client systems, a Risk Analysis system, a Front Office system, a Performance Analysis system, and a Data Store system. Then, the data transformation element 20 can send the data to the outputs OP1-OP4 in the forms required by those client systems. A dashed line 15 is shown on the graphical display to indicate the boundary between a server-side 30 of the system and a client-side 40 of the system.

In one embodiment, the transformation element 20 comprises a first set of transformation parameters defining how the data which is sent to the Risk Analysis system should be transformed, a second set of transformation parameters defining how the data which is sent to the Front Office system should be transformed, third set of transformation parameters defining how the data which is sent to the Performance Analysis system should be transformed, and a fourth set of transformation parameters defining how the data which is sent to the Data Store should be transformed.

The transformation parameters for the data which is sent to the Data Store specify that all the data which is sent to the other three client systems should be sent, and at the highest possible accuracy. The transformation parameters for the data which is sent to the Performance Analysis client system provide the highest available accuracy, but filter the data down to only a few different variables by which performance is judged. The transformation parameters for the data which is sent to the Risk Analysis client system do not transform the data with as much accuracy as those for Performance Analysis, and do not filter out so many of the data variables, to enable risks to be calculated. The transformation parameters for the data which is sent to the Front Office client system provide a few specific data variables, with a lower accuracy requirement, so that a general overview can be obtained by management staff.

In this embodiment, the four client systems are systems of a single client, and the data which is output may be a sub-set of the overall data which is received at the data transformation element 20 from the inputs IP1-IP4. In alternate embodiments there may be further outputs for further client systems. Typically, only the client systems for one client are shown in any one graphical display, although the overall data management system typically includes outputs for many different clients. Then, there is a corresponding graphical display for each one of the clients, so each client can view the data flow amongst the client's various systems on the corresponding graphical display.

The data is sent from the data transformation element to each one of the client systems via a respective outbound control point, labeled 5-8 in FIG. 1. The outbound control points are similar to the inbound control points, in that they judge and give a visual indication of the quality of data flowing through them. However, the outbound control points judge the quality of the data according to criteria sets based on the different requirements of the client systems. Therefore, whilst the data transformation element may transform the data based on different transformation parameters, the outbound control points may give a visual report of whether the transformed data actually meets the required criteria. The level of accuracy, and the data variables that are required, in order for the criteria set to determine an acceptable level of data quality, will vary depending on the particular client system to which the data is being output. The criteria set for each one of the control points may be specified by the client, based on the client's requirements.

The client systems may process the data, and then output the data in the form of various reports which can be read by subsequent systems and/or people. The reports may be output via a respective client control point for each one of the client systems, the client control points monitoring whether the data used in the reports is sufficiently accurate, complete, and appropriate for the purposes of the report. In the case of the Data Store client system, the data store passes data to a Data Manager via a client control point 12, and the Data Manager outputs Data Reports via another client control point 13. The data which is output by the client systems may include data which is generated by the client systems, for example the Data Manager system may generate metadata on the data which is received by the Data Store, such as statistics on data quality.

The client control points are similar to the inbound and outbound control points, and judge data quality based on criteria sets specified by the client. In the embodiment illustrated in FIG. 1, the graphical display 50 includes the client control points, although in alternative embodiments the graphical display may only show the flow of data up to the client systems, or even only show the flow of data up to the outputs OP1-OP4.

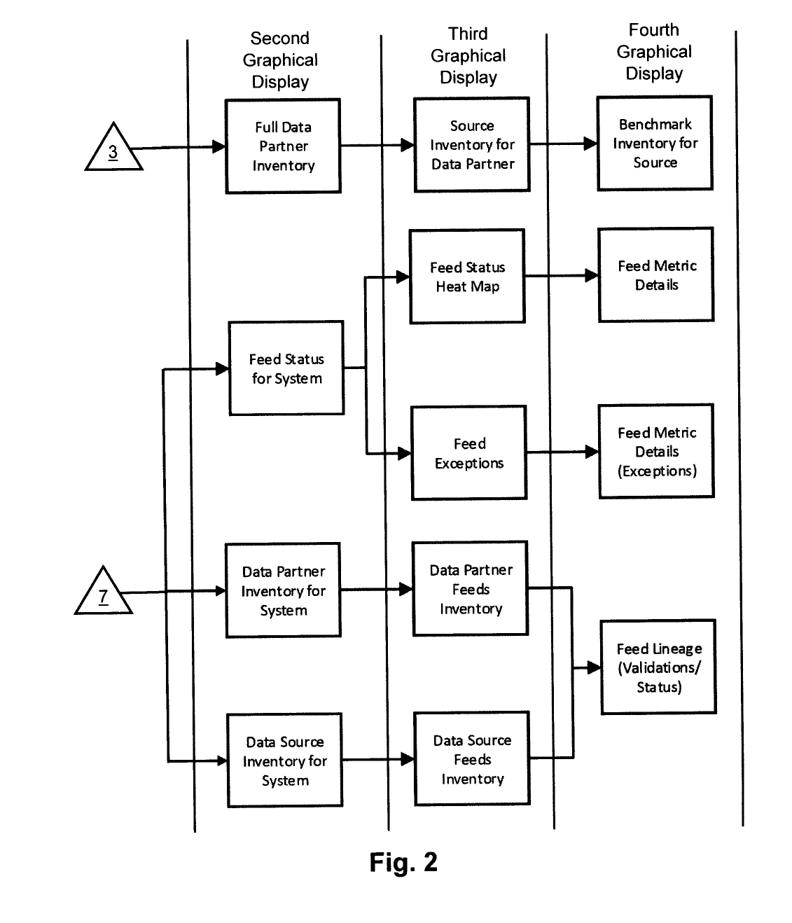

The graphical display 50 may be considered to be a first graphical display, and further graphical displays may be displayed by selecting the control points displayed in the first graphical display. The selection of a control point yields further information on the data passing through the control point, so the user can gain further details on the data, and determine where/why lapses in data quality may have occurred. FIG. 2 shows a hierarchy of second, third, and fourth graphical displays which may be accessed by selection of the inbound control point 3 via which Benchmark Data is sent. Upon selection of the inbound control point 3 on the first graphical display, a second graphical display is displayed, the second graphical display showing a full inventory of the data partners (providers) that provide data to the control point 3. The second graphical display indicates the data quality of the data that is received from each one of the data partners in the inventory. Accordingly, if the control point 3 indicates that the data quality is unacceptable, then selecting the control point 3 to show the second graphical display, may allow the user to identify which of the data partners has provided data of unacceptable data quality.

In this embodiment, the second graphical display is displayed within a pop-up window on a screen upon which the first graphical display is displayed. Optionally, cost allocation reports and usage reports may also be displayed on the second graphical display. The second graphical display may also be accessed by selecting one of the other inbound control points, and the data partners which are shown in the second graphical display will be the data partners that provide data to the selected inbound control point.

The user can select one of the data partners to yield a third graphical display within a pop-up window on the screen, the third graphical display showing an inventory of data sources for the selected data partner. The third graphical display indicates the data quality of the data that is received from each one of the data sources of the selected data partner. Accordingly, if the second graphical display indicates the data quality from a particular data partner is unacceptable, then selecting that data partner to display the third graphical display, may allow the user to identify which of the data sources of the selected data partner has provided data of unacceptable data quality.

Furthermore, the user can select one of the data sources to yield a fourth graphical display within a pop-up window on the screen, the fourth graphical display showing an inventory of benchmarks for the selected data partner. The fourth graphical display indicates the data quality of the data of each one of the benchmarks for the selected data partner. The data qualities in the second to fourth graphical displays may be displayed in a similar manner to the data qualities in the first graphical display, for example by displaying a visual indication such as a color that corresponds to the data quality of each associated item.

FIG. 2 shows a hierarchy of second, third, and fourth graphical displays which may be accessed by selection of the outbound control point 7 via which data is sent to the Performance Management system of the client. Upon selection of the inbound control point 7 on the first graphical display, a second graphical display is displayed on the screen in a pop-up window, the second graphical display showing three lists including a list of the statuses of the data feeds which supply the Performance Management system, a list of the data partners which supply data to the Performance Management system, and a list of the data sources which supply data to the Performance Management system. Clearly, if the user selects the outbound control point 5 on the first graphical display, then the lists will be with reference to the data that is sent to the Risk Analysis system, or if the user selects the outbound control point 6 on the first graphical display, then the lists will be with reference to the data that is sent to the Front Office system. Each data partner may provide data to the data transformation element 20 from a plurality of different sources.

In the second graphical display, the user may select one of the feeds in the list of data feeds, to yield a third graphical display in a pop-up window on the screen, the third graphical display showing a heat map for the data feed, and a list of exceptions for the data feed. The heat map provides a visual indication of the quality of data for the data feed, and may for example range from a Green color for acceptable data quality, to a Red color for unacceptable data quality. The list of exceptions is a list of instances of errors in the data feed, so the user can determine whether one of these errors may have contributed to a reduction in the data quality displayed by the control point. The user may select the heat map or the exceptions to yield a fourth graphical display in a pop-up window on the screen, the fourth graphical display showing feed metrics which were used to determine the heat map and/or the exceptions.

Alternatively, in the second graphical display, the user may select one of the data partners in the list of data partners, to yield a third graphical display in a pop-up window on the screen, the third graphical display showing a feeds inventory for the selected data partner. The user may select the one of the feeds in the feed inventory, to yield a fourth graphical display in a pop-up window on the screen showing feed lineage (validations/ statuses) of the selected data feed.

Alternatively, in the second graphical display, the user may select one of the data sources in the list of data sources, to yield a third graphical display in a pop-up window on the screen, the third graphical display showing a feeds inventory for the selected data source. The user may select the one of the feeds in the feed inventory, to yield a fourth graphical display in a pop-up window on the screen showing feed lineage (validations/statuses) of the selected data feed.

The user may navigate through the second, third, and fourth graphical displays to analyze the data flowing through the control point selected in the first graphical display. As with the second, third, and fourth graphical displays that can be navigated to from the inbound control points, the second, third, and fourth graphical displays that can be navigated to from the outbound control points also display the quality of data associated with each of the listed data partners, data sources, data feeds, and/or benchmarks. Therefore, a user can navigate through the graphical displays to help determine the causes of the outbound control point indicating an unacceptable data quality.

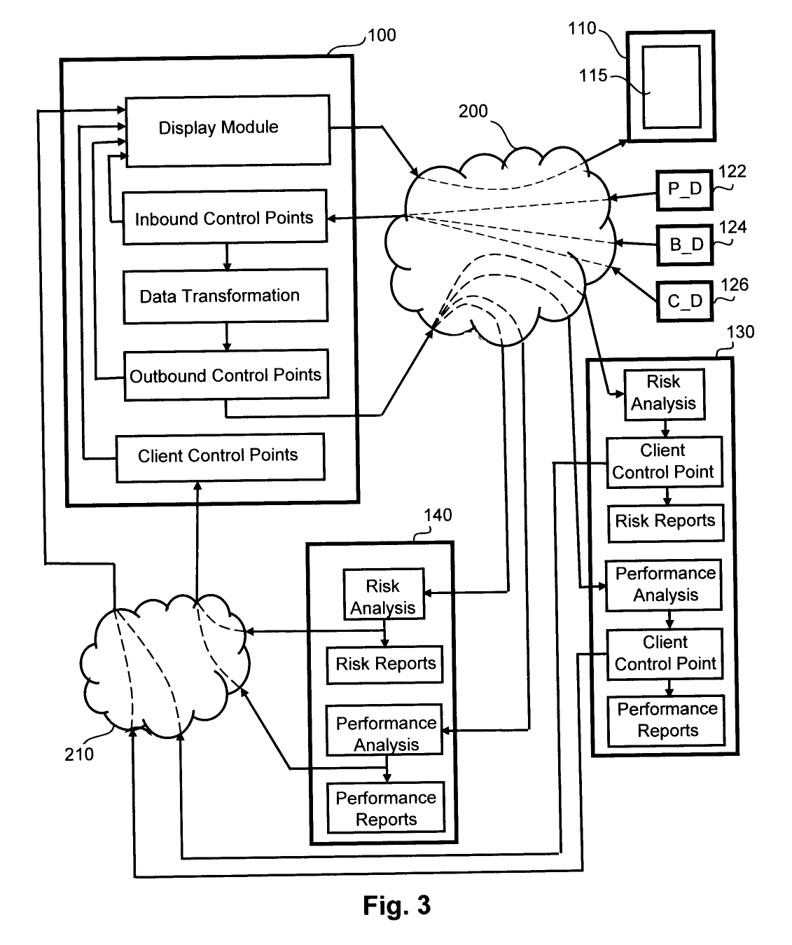

An example data management system for implementing the control points and generating the above first to fourth graphical displays will now be described with reference to FIG. 3. FIG. 3 shows a plurality of data sources 122, 124, 126, which send data feeds to a server computer 100 over the Internet 200. The data sources are typically computing devices, for example computer servers of data partners.

The computer server 100 is also connected to a smartphone 110 and first and second client systems 130, 140 via the Internet 200. The Internet 200 is represented in two different places on FIG. 3, for ease of representation, although there is clearly only one Internet.

The computer server 100 comprises an Inbound Control Points module, a Data Transformation module (element), an Outbound Control Points module, a Client Control Points module, and a Display Module. These modules are typically defined by computer software running on a computer processor of computer server 100, as will be apparent to those skilled in the art. In this embodiment, the computer server 100 is at a single site, although the various modules of the computer server could be distributed amongst a plurality of sites in alternate embodiments and connected via a network such as the Internet.

The data partners 122-126 send data feeds to the Inbound Control Points module of the computer server 100, specifically the data partner 122 sends Portfolio Data, the data partner 124 sends Benchmark Data, and the data partner 126 sends Complex Market Data. There is a respective inbound control point implemented by the Inbound Control Point module for each one of the data feeds from the data partners. In this embodiment, inbound control points similar to 1, 3, and 4 of FIG. 1 are implemented, and the inbound control point 2 of FIG. 1 has not been implemented since no Reference Data feed is received in this embodiment. Each inbound control point determines the quality of data passing through it according to a respective criteria set, and sends the determined data quality to the Display Module.

The data feeds pass from the inbound control points to the Data Transformation module, which implements a Data Transformation element similar to Data Transformation element 20 shown and described in relation to FIG. 1. The Data Transformation module sends transformed data for output to the first client system 130 via two outbound control points similar to 5 and 7 of FIG. 1, which are implemented in the Outbound Control Points module of server computer 100. The Data Transformation module also sends transformed data for output to the second client system 140 via another two outbound control points similar to 5 and 7 of FIG. 1, which are also implemented in the Outbound Control Points module of server computer 100.

In this embodiment, each of the client systems 130 and 140 is at a single respective site, although the various parts of each client system could be distributed amongst a plurality of sites in alternate embodiments and connected via a network such as the Internet.

The outbound control points which output to the first client system 130 have different criteria sets to the outbound control points which output to the second client system 140, since the first and second client systems 130 and 140 require different levels of data quality. Preferably, the criteria sets for the outbound control points connected to the first client system are defined by the first client system, and the criteria sets for the outbound control points connected to the second client system are defined by the second client system.

Each one of the client systems 130 and 140 has a Risk Analysis system and a Performance Analysis system, which receive data from the outbound control points. In this particular embodiment, only outbound control points similar to 5 and 7 of FIG. 1 have been implemented in the Outbound Control Points module of computer server 100, since the clients 130 and 140 only have Risk Analysis and Performance Analysis systems, and not Front Office and Data Store systems. Each outbound control point determines the quality of data passing through it according to its criteria set, and sends the determined data quality to the Display Module.

The first client system 130 comprises a Client Control Point connected to an output of each one of the Risk Analysis and Performance Analysis systems. The Risk Analysis system outputs data for Risk Reports via one Client Control Point, and the Performance Analysis system outputs data for Performance Reports via the other Client Control Point. Each one of the Client Control Points of first client system 130 determines the quality of data passing through it according to a respective criteria set, and sends the determined data quality to the Display Module of the server computer 100 via the Internet 200. The criteria sets of these Client Control Points are defined by the first client system 130.

The second client system 140 differs from the first client system 130, in that it does not comprise any Client Control Points. Instead, data from the Risk Analysis system is output directly for Risk Reports, and data from the Performance Analysis system is output directly for Performance Reports. In the case of the second client system 140, the Client Control Points are implemented on the computer server 100, and the data which is output for Risk Reports and Performance Reports is sent to the Client Control Points of the computer sever 100, as shown in FIG. 3.

Each one of the Client Control Points of the computer server 100 determines the quality of data passing through it according to a respective criteria set, and sends the determined data quality to the Display Module of the server computer 100. The criteria sets of these Client Control Points are preferably defined by the second client system 140.

The Display Module of the computer server 100 receives the determined data qualities from the inbound, outbound, and client control points, and generates a graphical display for each of the first and second clients 130 and 140, similar to the graphical display 50 of FIG. 1. The graphical display for the first client includes the inbound control points, the outbound control points via which data is sent to the first client, and the client control points of the first client. The graphical display for the second client includes the inbound control points, the outbound control points via which data is sent to the second client, and the client control points of the computer server 100 which receive data from the second client.

The graphical displays can be sent for display to authorized users, for example in this embodiment the graphical display for the first client 130 is sent to the touchscreen display 115 of the smartphone 110. The user of the smartphone 110, who is part of the organization of the first client, has logged into the computer server 100 via the Internet 200, and so is authorized to access the graphical display for the first client.

The user of the smartphone 110 can use the touchscreen 115 to select one of the displayed control points to receive more information on the data flowing through the selected control point, as discussed earlier in relation to FIG. 2. Clearly, the graphical displays could be sent to a variety of different types of computing device for display. Furthermore, a composite graphical display showing all the control points of both the first and second client systems may be generated by the computer server 100, although access to this composite graphical display may be restricted to the operators of the computer server 100 for security reasons.

Further embodiments falling within the spirit and scope of the present invention will also be apparent to those skilled in the art.

1. A data management system for managing flow of data though from a plurality of inputs to a plurality of outputs via a data transformation element, the system comprising a plurality of control points and a first graphical display of the inputs, outputs, and the data transformation element, wherein each control point determines the quality of the data at a respective point in the data flow between the inputs and outputs, and wherein each control point is represented in the first graphical display together with a visual indication of the data quality determined by the control point.

2. The data management system of claim 1, wherein the control points comprise inbound control points between the inputs and the data transformation element in the data flow, and outbound control points between the data transformation element and the outputs in the data flow.

3. The data management system of claim 2, wherein at least one of the inbound control points determines the quality of data according to a first criteria set, and wherein at least one of the outbound control points determines the quality of data according to a second criteria set, wherein the first and second criteria sets are different to one another.

4. The data management system of claim 2, wherein the data transformation element is configured to receive, transform, and subsequently send data from one of the inputs to at least two of the outputs, wherein the outbound control point between the data transformation element and one of the at least two outputs determines the quality of data according to one criteria set, and wherein the outbound control point between the data transformation element and another one of the at least two outputs determines the quality of data according to another criteria set.

5. The data management system of claim 4, wherein the transforming of the data comprises at least one of formatting, organizing, and filtering the data.

6. The data management system of claim 4, wherein the transforming of the data comprises transforming the data using a first set of transformation parameters for the data which is sent to a first one of the at least two outputs, and transforming the data using a second set of transformation parameters for the data which is sent to a second one of the at least two outputs, wherein the first and second sets of transformation parameters are different to one another.

7. The data management system of claim 1, wherein the visual indication of the data quality determined by each control point comprises visual indications of each one of the accuracy, completeness, and appropriateness of the data.

8. The data management system of claim 1, wherein the visual indication of the data quality comprises a visual indicator having a colour corresponding to the determined quality of the data.

9. The data management system of claim 1, wherein the control points on the first graphical display are selectable by a viewer of the first graphical display, and wherein the selection of a control point results in the display of more detailed information on the quality of the data at the point in the data flow corresponding to the selected control point.

10. The data management system of claim 9, wherein the more detailed information comprises information on at least one of the accuracy, completeness, and appropriateness of the data.

11. The data management system of claim 9, wherein the selection of a control point results in the display of the more detailed information in a second graphical display, wherein the second graphical display includes an inventory of data partners from which the data at that control point was obtained.

12. The data management system of claim 11, wherein the data partners of the inventory of data partners on the second graphical display are selectable by a viewer of the second graphical display, and wherein the selection of a data partner results in the display of a third graphical display including an inventory of data sources for the selected data partner.

13. The data management system of claim 12, wherein the data sources of the inventory of data sources on the third graphical display are selectable by a viewer of the third graphical display, and wherein the selection of a data source results in the display of a fourth graphical display including an inventory of benchmarks for the selected data source.

14. The data management system of claim 1, wherein the inputs, control points, and the data transformation element are implemented on a server computer, and wherein the server computer is configured to output the first graphical display to a client computing device over a network.

15. The data management system of claim 14, wherein the network is the Internet.

16. The data management system of claim 14, wherein the server computer is configured to output the data from the plurality of outputs to a respective plurality of client data systems over a network.

17. The data management system of claim 16, wherein each control point between the data transformation element and a respective output determines the quality of data according to a criteria set that is defined by the client data system to which the output outputs the data.

18. The data management system of claim 16, further comprising a plurality of client control points, wherein the client control points receive data from outputs of the client data systems, wherein each client control point determines the quality of the data it receives, and wherein each client control point is represented in the first graphical display together with a visual indication of the data quality determined by the client control point.

19. The data management system of claim 18, wherein the client control points are implemented on the server computer, and wherein the data from the outputs of the client data systems is received by the server computer over the network.

20. The data management system of claim 18, wherein the client control points are implemented on a client computer, and wherein the quality of data determined by each client control point is sent to the server computer over the network for inclusion in the first graphical display.

21. The data management system of claim 18, wherein each client control point determines the quality of data according to a criteria set that is specific to the client data system from which the data was sent to the client control point.

22. The data management system of claim 1, wherein the first graphical display is output for display on a display screen of a computer, smartphone or tablet.

23. The data management system of claim 1, wherein the inputs are configured to receive data feeds comprising at least one of financial benchmarking data, financial portfolio data, and complex market data, wherein complex market data includes derivatives, private equity, commodities, or hedge funds.
